(19) United States
(12) Patent Application Publication
(10) Pub. No.: US 2012/0167809 A1
(43) Pub. Date: Jul. 5, 2012

(54) AGRICULTURAL IMPLEMENT HAVING FLUID DELIVERY FEATURES

(75) Inventor: Joseph D. Bassett, Sycamore, IL (US)

(73) Assignee: Dawn Equipment Company, Sycamore, IL (US)

(21) Appl. No.: 13/343,800

(22) Filed: Jan. 5, 2012

Related U.S. Application Data
(60) Provisional application No. 61/430,012, filed on Jan. 5, 2011.
(60) Provisional application No. 61/435,851, filed on Jan. 25, 2011.

(51) Int. Cl. A01C 23/00; A01C 5/06

(52) U.S. Cl. 111/119; 111/120

(57) ABSTRACT

An agricultural implement for delivering fluid fertilizer into a furrow in the soil of an agricultural field includes a main frame, an opener device attached to the main frame for forming a furrow in the soil, a closing device having an axis of rotation and trailing the opener device for closing the furrow, and a dispensing device for delivering a fluid into the furrow. The injection device has a bottom end extending downwardly into the furrow between the opener device and the axis of rotation of the closing device, an inlet port for receiving the fluid, at least two outlet ports for discharging the fluid into different regions of the furrow, and a bifurcated passageway for conducting the fluid from the inlet port to the outlet ports. The outlet ports may be located to discharge the fluid onto or adjacent to both of the side walls of the furrow.

### RELATED APPLICATIONS

This application is related to and claims priority to U.S. Provisional Patent Application No. 61/430,012, filed Jan. 5, 2011, and U.S. Provisional Patent Application No. 61/435,851, filed Jan. 25, 2011, each of which is incorporated herein in its entirety.

### FIELD OF THE INVENTION

The present invention relates generally to agricultural equipment and, more particularly, to an implement having an assembly for efficient delivery of a fluid to a furrow.

### BACKGROUND OF THE INVENTION

One of the common forms of fertilizer used in agricultural fields is ammonia gas, which functions as a nitrogen fertilizer when delivered into the soil. Although ammonia gas has been used as an agricultural fertilizer for many years, problems remain in achieving efficient and effective delivery of ammonia gas into soil before vapor escapes to the atmosphere and is chemically attached into the soil. Problems are also caused by the cooling effect caused by expansion of the ammonia gas as it is discharged onto the soil, which causes freezing of soil and moisture on the implement, leading to adverse effects on performance.

Similar problems are present in delivery of other types of products, such as liquid nitrogen, water, etc. For example, mixing of chemicals prior to injection into the furrow results in inefficient delivery of the chemicals to the soil. Specifically, the inefficient delivery causes loss of quantities of the reacting chemicals.

Typical agricultural implements for delivering fertilizer or other chemical products to an agricultural soil fail to achieve efficient delivery of the respective products. One problem of present agricultural implements is directed to fertilizer coulter assemblies that fail to achieve different size fertilizer openings or different levels of soil and residue disturbance. Typically, only a single size can be achieved for a fertilizer opening and a single level can be achieved for soil and residue disturbance. However, present agricultural implements fail to create an adjustable cavity size to accommodate different volumes of products and/or different types of products (e.g., manure vs. ammonia) that can be deposited into the soil.

What is needed, therefore, is an agricultural implement for delivering a fluid to an agricultural soil that addresses the above-stated and other problems.

### SUMMARY OF THE INVENTION

In one embodiment, an agricultural implement for delivering fluid fertilizer into a furrow in the soil of an agricultural field includes a main frame, an opener device attached to the main frame for forming a furrow in the soil, a closing device having an axis of rotation and trailing the opener device for closing the furrow, and a dispensing device for delivering a fluid into the furrow, the injection device having a bottom end extending downwardly into the furrow between the opener device and the axis of rotation of the closing device, an inlet port for receiving the fluid, at least two outlet ports for discharging the fluid into different regions of the furrow, and a bifurcated passageway for conducting the fluid from the inlet port to the outlet ports. In one implementation, the outlet ports are located to discharge the fluid onto or adjacent to both of the side walls of the furrow. The dispensing device may include at least two inlet ports for receiving two different fluids.

The dispensing device may have a bottom wall having a width that is narrower than the average width of the bottom half of the furrow, and side walls that extend upwardly and outwardly from the bottom wall to engage the side walls of the furrow, thereby forming cavities in the furrow between the side walls of the injection device and the side walls of the furrow.

In another embodiment, a method of delivering fluid fertilizer into a furrow in the soil of an agricultural field uses an opener device for forming a furrow in the soil, a closing device having an axis of rotation and trailing the opener device for closing the furrow, and a dispensing device for delivering a fluid into the furrow. The dispensing device is located between the opener device and the axis of rotation of the closing device, and the fluid fertilizer is delivered from the dispensing device into at least two different regions of the furrow. The fluid fertilizer may be ammonia gas.

In one implementation, the fluid fertilizer comprises two different fluids, one of which is a pressurized liquid and the other of which is a gas pressurized to a pressure above that of the pressurized liquid. The pressurized liquid may be discharged rearwardly from a location above the bottom of the furrow, while the pressurized gas is discharged downwardly into the bottom of said furrow.

### BRIEF DESCRIPTION OF THE DRAWINGS

The invention may best be understood by reference to the following description taken in conjunction with the accompanying drawings, in which:

FIG. 1 is a side elevation of a portion of an agricultural tillage implement that includes an opener disc, an ammonia delivery tube and a closing wheel.

FIG. 2 is a top plan view of the devices shown in FIG. 1.

FIG. 3 is a perspective view of the devices shown in FIG. 1.

FIG. 4 is an enlarged perspective view of the diffuser tip on the trailing end of the ammonia delivery tube shown in FIGS. 1-3.

FIG. 5 is a side elevation of the diffuser tip shown in FIG. 4.

FIG. 6 is a side elevation of an agricultural tillage implement that includes an injection tine assembly.

FIG. 7 is a side elevation of the tine assembly shown in FIG. 6.

FIG. 8 is a partial cross-sectional view of the injection tine assembly shown in FIG. 7.

FIG. 9 is a front plan view of the tine assembly shown in FIG. 6.

FIG. 10 is a cross-sectional view of the injection tine assembly shown in FIG. 9, including a diffuser.

FIG. 11 is a perspective view of the injection tine assembly shown in FIG. 6.

FIG. 12 is an enlarged cross-sectional view of the diffuser shown in FIG. 10.

FIG. 13 is a perspective of an agricultural tillage implement, according to an alternative embodiment.

FIG. 14 is a side view of the agricultural tillage implement of FIG. 13.

FIG. 15 is a top view of the agricultural tillage implement of FIG. 13.

FIG. 16 is a cross-sectional top view showing some of the components of the agricultural tillage implement of FIG. 13.

FIG. 17 is an enlarged view showing a variation of a tine assembly of the agricultural tillage implement of FIG. 13.

FIG. 18 is rear view illustration showing rotational movement of an injection tine around the X axis.

FIG. 19A is a top view illustration showing rotational movement of an injection tine around the Z axis.

FIG. 19B is front view illustration showing rotational movement of the injection tine around the X axis.

FIG. 19C is a side view illustration showing rotational movement of the injection tine around the Y axis.

FIG. 20 is an illustration representing rotational movements of the injection tine and of an adjustable opener disc.

FIG. 21 is a side elevation of a modified embodiment of an agricultural tillage implement that includes an opener disc, an ammonia delivery tube and a closing wheel.

FIG. 22 is an enlarged top plan view of the fertilizer-dispensing portion of the embodiment shown in FIG. 21.

FIG. 23 is side elevation of the fertilizer-dispensing portion shown in FIG. 22.

FIG. 24 is an end elevation of the fertilizer-dispensing portion shown in FIG. 22.

FIG. 25 is an enlarged perspective of the central portion of the embodiment of FIG. 21 dispensing fertilizers into a furrow.

FIG. 26 is an enlarged side elevation of the lower portion of a modified fertilizer-dispensing device.

FIG. 27 is a rear elevation of the device shown in FIG. 26.

FIG. 28 is a front elevation of the device shown in FIG. 26.

FIG. 29 is a section taken along line 29-29 in FIG. 26.

FIG. 30 is a section taken along line 30-30 in FIG. 26.

FIG. 31 is a section taken along line 31-31 in FIG. 26.

FIG. 32 is a section taken along line 32-32 in FIG. 26.

FIG. 33 is a section taken along line 33-33 in FIG. 26.

FIG. 35 is a front elevation of a modified fertilizer-dispensing device having a different shapes that can be used in place of the shape illustrated in FIG. 28.

FIG. 36 is a top plan view of another modified dispensing device, along with a diagrammatic illustration of a furrow.

FIG. 37 is a side elevation of a complete row unit utilizing the dispensing device shown in FIG. 36, and showing enlargements of portions of the row unit.

FIG. 38 is an enlarged side elevation of the lower portion of the dispensing device in the row unit of FIG. 37.

FIG. 39 is an exploded rear perspective of the mounting arrangement for the dispensing device in the row unit of FIG. 37.

FIG. 40 is an exploded front perspective of the mounting arrangement for the dispensing device in the row unit of FIG. 37.

FIGS. 41A and 41B are rear perspectives of another modified dispensing device, with the addition of a diagrammatic illustration of a furrow in FIG. 41A.

FIG. 42 is a diagrammatic illustration of a fertilizer dispensing device and an opening disc, with field debris passing between the two devices.

### DETAILED DESCRIPTION OF ILLUSTRATED EMBODIMENTS

Although the invention will be described in connection with certain preferred embodiments, it will be understood that the invention is not limited to those particular embodiments. On the contrary, the invention is intended to cover all alternatives, modifications, and equivalent arrangements as may be included within the spirit and scope of the invention as defined by the appended claims.

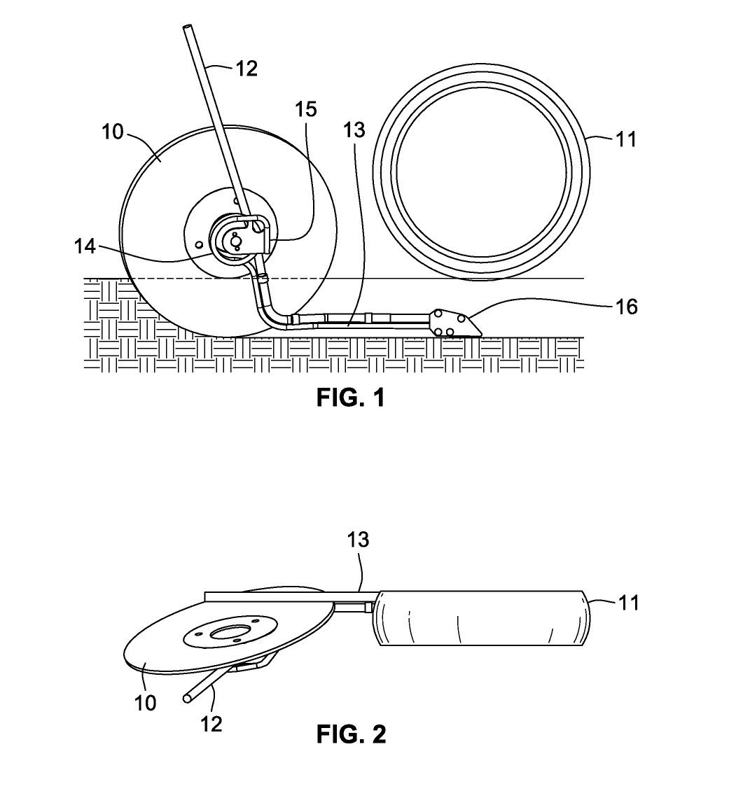

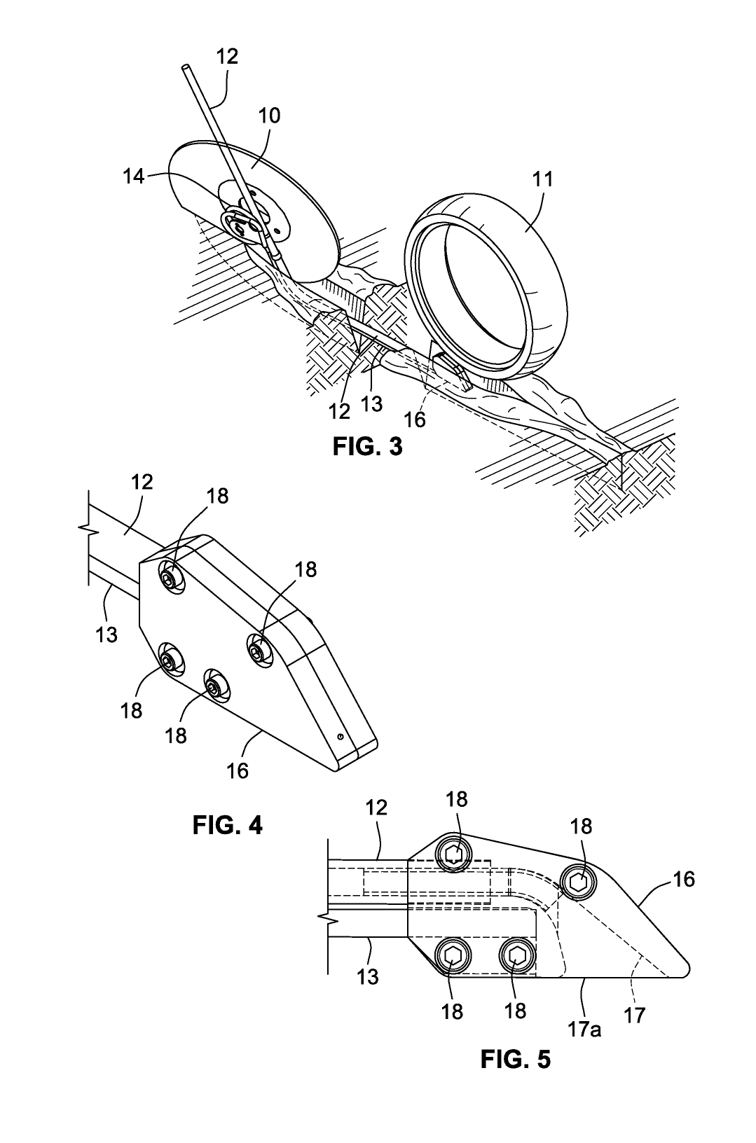

Turning now to the drawings and referring first to FIGS. 1-3, the illustrative agricultural tillage and fertilizing implement includes a cutting device such as an opener disc 10 for forming a furrow for receiving fertilizer, and a closing device such as a closing wheel 11 for closing the furrow after fertilizer has been delivered into the furrow. Those working in the agricultural field sometimes use the term “slot” instead of “furrow.” Both the opener disc 10 and the closing wheel 11 are mounted on brackets depending from a conventional frame adapted to be towed by a tractor. A portion of a bracket 15 carrying the opener disc 10 is shown in FIG. 1.

The illustrative opener disc 10 is tilted slightly, as can be seen in FIGS. 1-3, but opener discs that are substantially vertical are also used for cutting furrows in soil. The opener disc 10 may be replaced with a conventional knife opener or “shank,” and the closing wheel 11 may be replaced with any of a variety of different closing devices that are well known in the agricultural implement industry. Both fertilizer and seeds may be deposited in the furrow before it is closed, when the implement is used as part of a tilling operation, or just fertilizer when the implement is used only for fertilizing and/or cultivating.

Extending downwardly along one side of the opener disc 10 is an ammonia delivery tube 12 for delivering ammonia gas into the furrow formed by the disc 10. The portion of the delivery tube that extends into the furrow is guided and supported by a tine 13 that extends downwardly from the bracket 15 and then bends rearwardly toward the closing wheel 11, preferably overlapping a portion of the closing wheel so that the ammonia is discharged into the furrow just before, or even just after, the furrow is closed. That is, the delivery tube 12 extends rearwardly along the bottom of the furrow to the closing wheel 11 and delivers ammonia gas onto at least one wall of the furrow in the vicinity of where the furrow is closed by the closing wheel. The tine 13 is preferably spring biased toward the bottom of the furrow by a conventional spring 14 mounted on the bracket 15 in which the axle of the opener disc is journaled. Alternatively, the tine itself may be made resilient so that it can be positioned near the bottom of the furrow with the ability to flex upwardly as required by the soil conditions. Also, the tine and the delivery tube may be integrated in a single part. The tine, or the single integrated part, can be made of either metal or polymeric material.

A discharge nozzle 16 (see FIGS. 4 and 5) is mounted on the trailing end of the ammonia delivery tube 12 for discharging ammonia gas onto at least the bottom of the furrow formed by the opener disc 10. As can be seen in FIG. 5, the discharge nozzle 16 forms an expansion chamber 17 to allow expansion of the ammonia gas just before the gas is discharged from the nozzle 16. This reduces the velocity at which the gas is discharged, thereby improving absorption of the ammonia in the soil by reducing the amount of ammonia that is deflected off the soil and out of the furrow. The exit opening 17a of the expansion chamber 17 is on the bottom of the nozzle 16 so that the gas is directed onto the bottom wall of the furrow formed by the opener disc 10. Because the tine 13 is biased downwardly, the nozzle 16 is maintained in engagement with the bottom of the furrow so that it is difficult for the pressurized ammonia gas to escape into the atmosphere rather than penetrating into the soil. The chamber 17 may also be provided with side holes to discharge ammonia gas onto the side walls of the furrow, as well as the bottom wall.

The exact shape and size of the chamber 17 is determined based on soil properties. For example, the volume of the chamber should be relatively lower when the moisture level of the soil is high than when the moisture level of the soil is low. Alternatively, the discharge nozzle 16 lacks the chamber 17 and functions solely as an insulator.

The ammonia gas delivery tube 12 and the discharge nozzle 16 may both be made of non-metallic material, such as a polymeric material, so that these components have low thermal conductivity. This is desirable because the expansion of the ammonia gas as it is released into the soil typically causes freezing in various conditions of temperature and humidity, and the freezing can have an adverse effect on performance. For example, moisture can become frozen in the gas discharge opening and reduce, or even interrupt, the delivery of ammonia into the soil. Soil and moisture can also freeze on the tine 13 and even on the soil-cutting device, especially when it is a non-rotating device such as a knife or shank. Forming the discharge nozzle and the delivery tube of polymeric material having low thermal conductivity thermally isolates the gas discharge area from the metallic portions of the implement, thereby preventing or at least reducing the freezing of soil and moisture on those metallic portions. For example, the ammonia gas delivery tube may be a polymeric hose, and the discharge nozzle 16 may be formed as a molded plastic clamshell attached to the trailing end of the tine 13 by multiple screws 18.

It will be understood that the ammonia is supplied to the delivery tube 12 from a pressurized tank carried by the implement. If desired, the ammonia from the tank can be fed to a pump that increases the pressure of the ammonia in the delivery tube so that a substantial portion of the ammonia is maintained in liquid form.

It can be seen that the discharge nozzle in the illustrative embodiment is positioned to release the ammonia gas directly below a portion of the closing wheel. This minimizes the tendency of the ammonia to escape as gas in the area between the point where the gas is released from the discharge nozzle and the point where the furrow is closed by the closing wheel 11.

The plastic discharge nozzle 16 is shaped to form a seal against the bottom and/or the sides of the furrow formed by the opener disk 10 (see FIG. 1). The expansion chamber 17 diffuses the ammonia gas so that the gas is exposed to a greater surface area of soil without being allowed to be exposed to the atmosphere, and to slow down the velocity of the fluid flow. Each unit of soil has a limited capacity to bind with ammonia, and thus increasing the area of soil that can bind with the ammonia, while limiting the ability of the ammonia to escape as gas to the atmosphere, generally improves the performance of the ammonia delivery device.

The implement described above may be used for tilling and fertilizing a field to be planted later, or in conjunction with a tillage implement that has a seed hopper and seed delivery device for depositing seed in the furrow between the cutting device and the closing device.

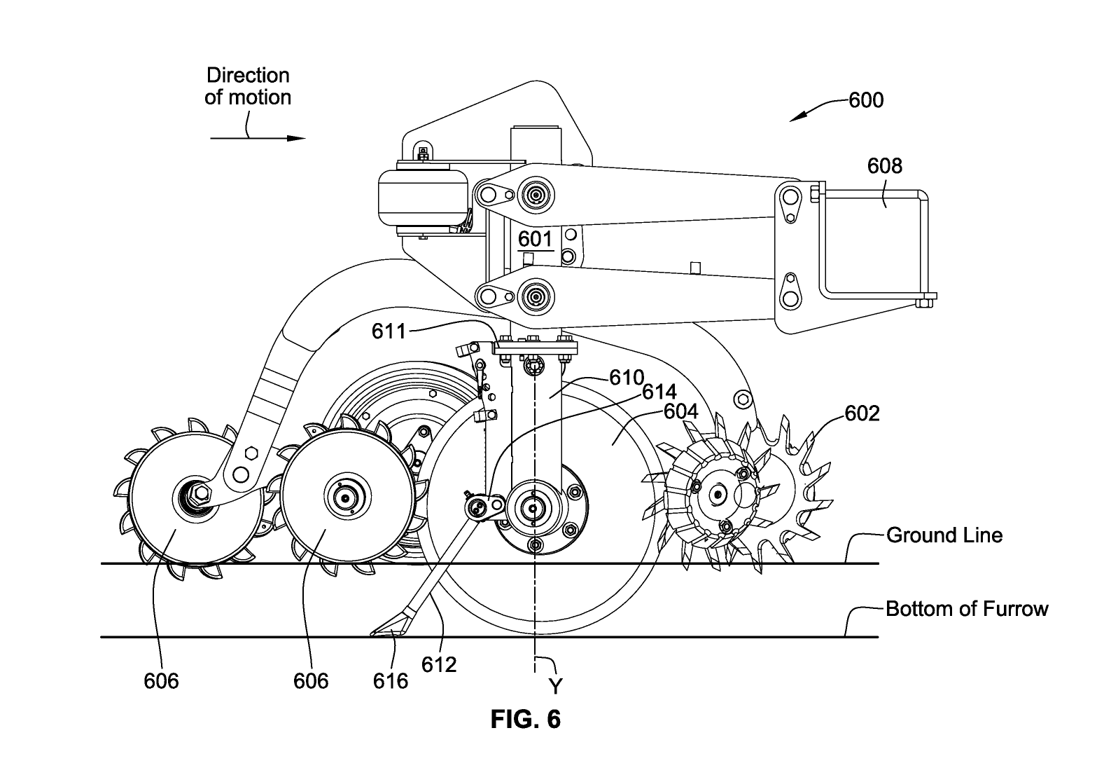

Referring to FIG. 6, a fertilizing assembly 600 includes advantageous features directed to an angular adjustment for an opener disc and to a coaxial tine for an injection tine assembly. The fertilizing assembly 600 includes a main frame 601 to which a plurality of residue clearing wheels 602, an opener disc 604, and a plurality of closing wheels 606 are attached. The fertilizing assembly 600 is attachable to a towing vehicle, such as a tractor, via a frame attachment 608. The opener disc 604 is mounted to the main frame 601 via a depending arm 610, which is positioned in a generally vertical position and has an angular adjustment axis of rotation Y.

The depending arm 610 can be adjusted around the axis of rotation Y at an arm mount 611 such that the angle of the opener disc 604 can be changed. The angular change of the opener disc 604 causes a specific furrow width to be created. In other words, if the opener disc 604 is oriented generally parallel to the length of the furrow, the width of the furrow will be smaller, and if the opener disc 604 is oriented generally towards a perpendicular orientation relative to the length of the furrow, the width of the furrow will be larger.

[The closing wheels 606 are mounted to the main frame 601 at a point above the arm mount 611 to provide a fixed position for the closing wheels 606 relative to the direction of motion of the tractor. Thus, adjustment of the depending arm 610 does not affect the position of the closing wheels 606.

The fertilizing assembly 600 further includes an injection tine assembly 612, which is coupled to the depending arm 610 at a pivoting end 614. Another end of the injection tine assembly 612 includes a diffuser (also referred to as a discharge nozzle) 616 that is generally biased toward the bottom of the furrow. The diffuser 616 is a general fluid discharge point that is placed in the furrow opened by the opener disc 604.

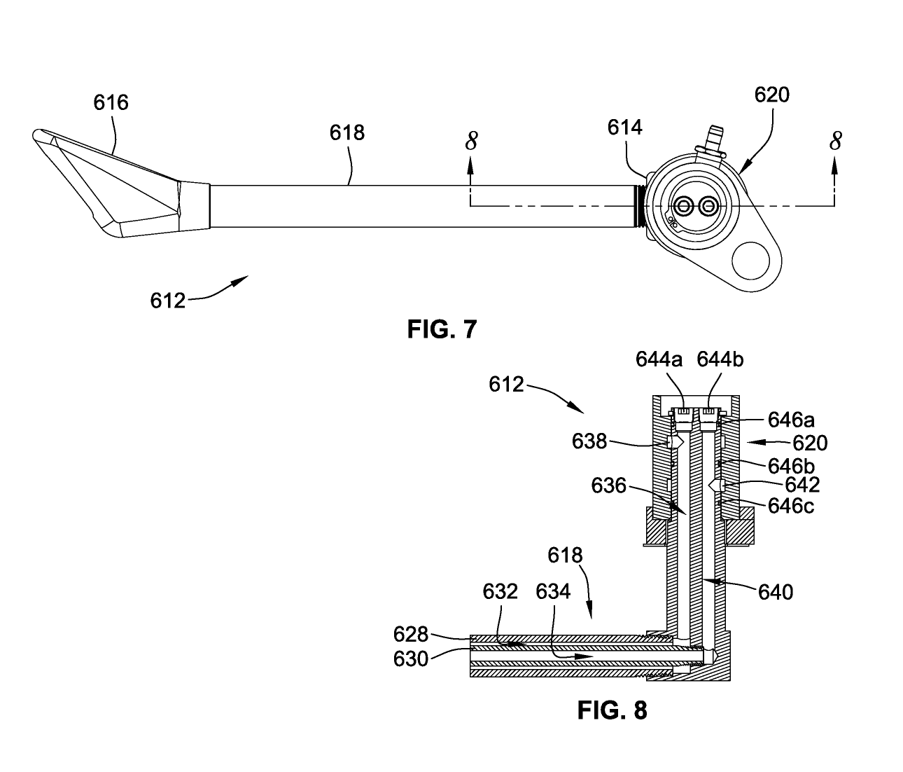

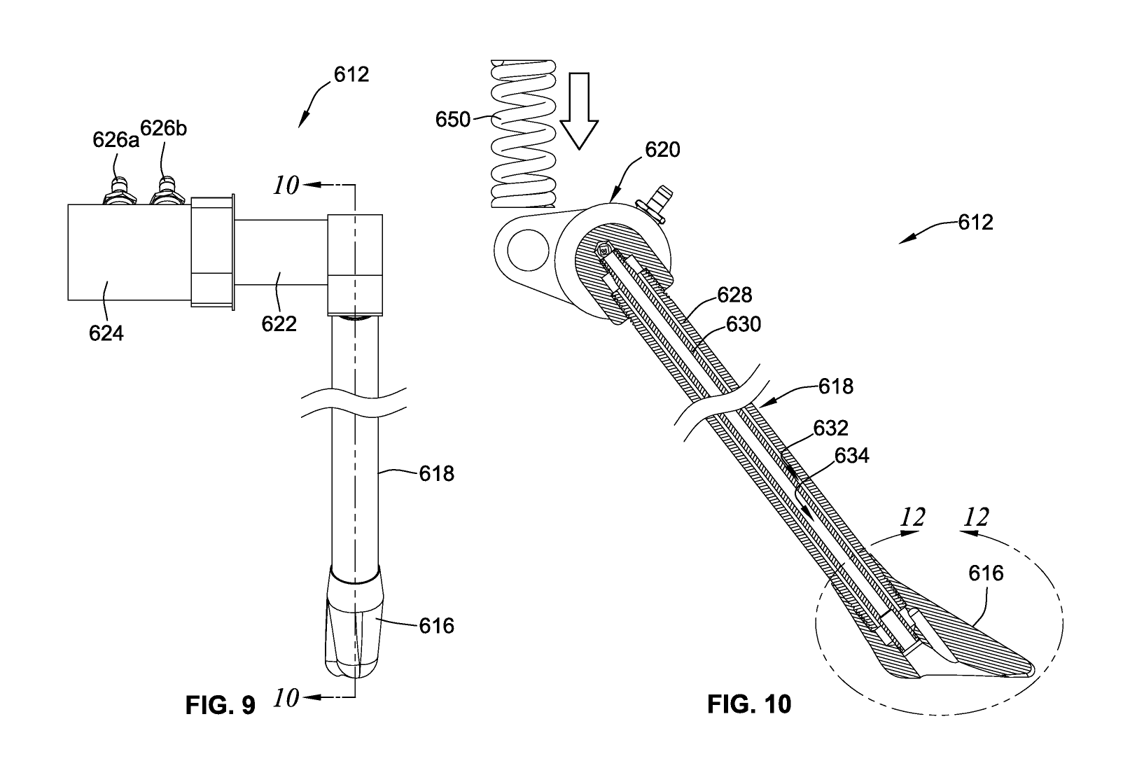

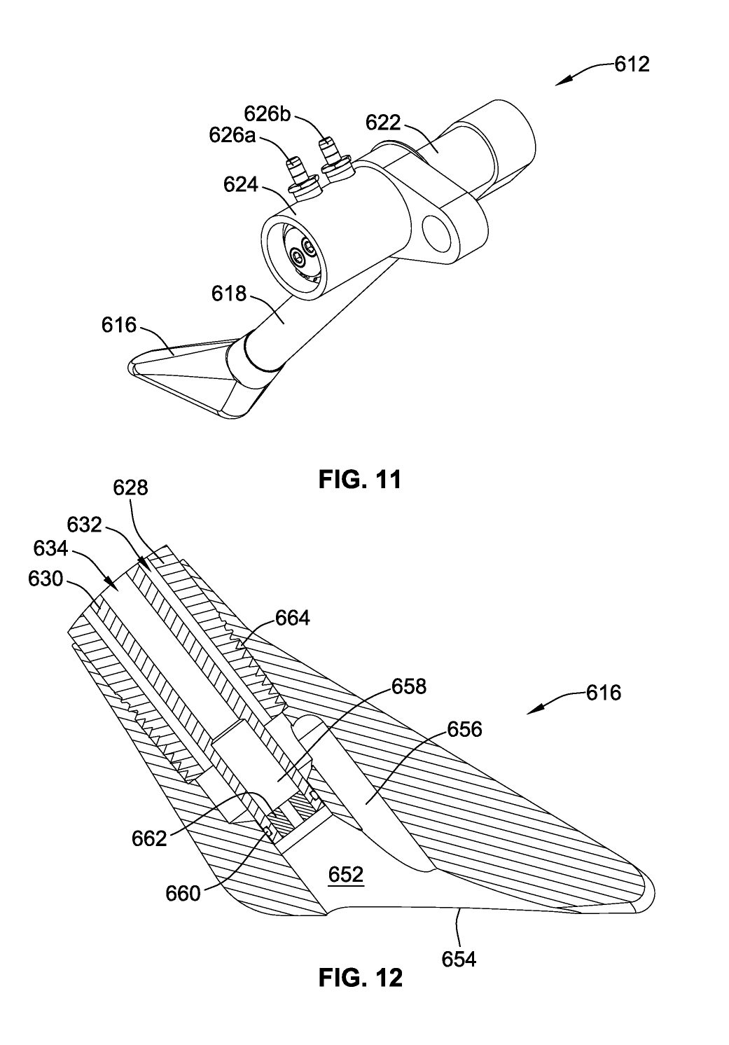

Referring to FIGS. 7-11, the injection tine assembly 612 includes a rod (or tine) 618 to which the diffuser 616 is connected at a bottom end, and to which a pivoting assembly 620 is connected at the pivoting end 614. The pivoting assembly 620 includes a pivoting shaft 622 and a fluid inlet housing 624, which includes a plurality of fluid inlet ports 626a, 626b.

As more clearly illustrated in FIG. 8, the rod 618 includes a plurality of coaxial tubes for forming passageways through which respective fluids flow toward the diffuser 616. Specifically, the coaxial tubes include an outer tube 628 and an inner tube 630. The outer tube 628 provides the primary structural support for the rod 618 and, typically, is formed from stainless steel material to provide good abrasion resistance to the soil and to resist highly corrosive agricultural products. A first fluid can flow through an outer passageway 632 that is formed between the outer tube 628 and the inner tube 630. A second fluid can flow, simultaneously with the first fluid, through an internal passageway 634 surrounded by the inner tube 630.

Referring to the pivoting assembly 620 and the fluid inlet housing 624 in more detail, the first fluid is inserted via a first tube 636 at a first insertion point 638, and the second fluid is inserted via a second tube 640 at a second insertion point 642. The first tube 636 and the second tube 640 of the pivoting assembly 620 are positioned parallel to each other in adjacent positions. A pair of plugs 644a, 644b prevent fluid flow in a direction away from the diffuser. A plurality of O-rings 646a, 646b, 646c are mounted to prevent fluid leaks near the fluid insertion points 638, 642. Delivering the fluids, which may generally include hazardous and caustic liquids, through the pivoting assembly 620 removes the need for having loose tubes near a dangerous blade area where crop residue tends to remain lodged. Accordingly, the pivoting assembly 620 provides a robust enclosure for chemical hose routings (e.g., the first tube 636 and the second tube 640) with increased safety and performance features.

For example purposes, it is assumed that the first fluid is water or an aqueous fertilizer solution and the second fluid is ammonia gas or ammonia liquid. According to the embodiment described above, water enters the pivoting assembly 620 at the first insertion point 638, flows through the first tube 636, and continues flowing through the outer passageway 632 of the rod 618 toward the diffuser 616. Similarly, ammonia gas enters the pivoting assembly 620 at the second insertion point 642, flows through the second tube 640, and continues flowing through the internal passageway 634 toward the diffuser 616. Before reaching a mixing chamber of the diffuser 616, the two fluids remain unmixed.

Referring more specifically to FIG. 10, the pivoting assembly 620 is biased in a downward position (toward the furrow) by a spring 650. The force of the spring helps maintain the diffuser 616 near the bottom of the furrow with the ability to flex upwardly as required by the soil conditions. For example, the pivoting assembly 620 allows the diffuser 616 to flex over rocks and obstructions. Optionally, in accordance with environmental conditions, the spring pressure is adjustable to provide a desired force.

Referring now to FIG. 12, the diffuser 616 has a generally rounded shape that prevents soil and/or plant residue from attaching to the rod 618 and, therefore, from interfering with the movement of the rod 618 through the furrow. The diffuser 616 includes a mixing chamber 652 and an exit opening 654. The first fluid enters the mixing chamber 652 via a first inlet opening 656 and the second fluid enters the mixing chamber 652 via a second inlet opening 658. A diffuser O-ring 660 seal prevents mixing of the two fluids before reaching the mixing chamber 652. Optionally, a removable plug 662 can be inserted in the second inlet opening 658 to temporarily prevent fluid flow from the internal passageway 634 into the mixing chamber 652.

When the fluids reach the mixing chamber 652, they mix to produce a chemical reaction. Because the mixing occurs in the expansion chamber 652, which is next to the bottom of the furrow, a more efficient chemical reaction is achieved, wherein little or no vapor loss occurs. For example, it is often advantageous to achieve mixing of anhydrous ammonia with a water-based liquid fertilizer product because the mixture alters the ammonia rapidly into a form that will not escape as a gas. The mixing chamber 652, which is only open toward the exterior environment on the bottom of the diffuser 616, at the exit opening 654, confines the chemical reaction to bias the byproduct of such a reaction toward the soil. Accordingly, the byproduct fertilizer is applied to the soil more efficiently by binding a higher quantity of fertilizer to the soil and minimizing loss to the air (wherein ammonia is lighter than air).

According to one embodiment, the diffuser 616 includes a plurality of threads 664 that are intended to engage mating threads on the rod 618 when connecting the diffuser 616 to the rod 618. The threads 665 of the diffuser 616 are optionally integratedly formed with the body of the diffuser 616. According to alternative embodiments, other fastening devices (such as adhesives) can be used to connect the diffuser 616 and the rod 618.

The diffuser 616 may be formed as a molded plastic casing using a compression molding process. The plastic material can be, for example, a UHMW (Ultra High Molecular Weight Polyethylene) material that is well suited for forming complex surface geometries. Another advantages of the UHMW material is that it provides high wear resistance. Alternatively, the diffuser 616 is formed (e.g., machined, cast, forged) from a metal material.

In addition to manufacturing advantages, the UHMW material is further desirable because it insulates the fluids from thermal transfer. For example, the diffuser 616 functions as an insulator and, also, maintains separation between the outer tube 628 and the inner tube 630. For example, if ammonia gas is supplied in the internal passageway 634, the diffuser 616 inhibits freezing of the discharge point of the ammonia gas in the mixing chamber 652. Additionally, the freezing of the ammonia gas (or any other internal fluid) along the rod 618 is further inhibited by the fluid being supplied in the outer passageway 632 (e.g., water), which functions as an additional layer of insulation. Based at least on these two insulating features of the injection tine assembly 612, current needs for typical “heat exchanger” expansion chambers (which are required for cooling and maintaining ammonia gas in a liquid state so that it can be metered accurately) is minimized.

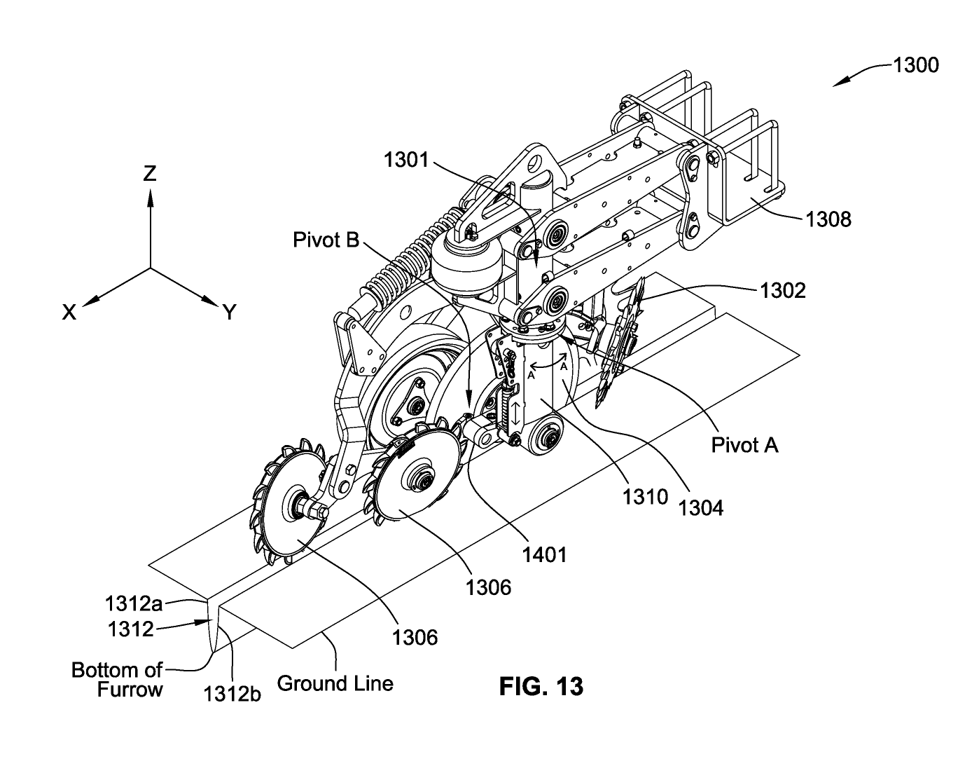

Referring to FIG. 13, an agricultural implement 1300, such as a fertilizer assembly, includes a main frame 1301 to which a plurality of residue clearing wheels 1302, an opener disc 1304, and a plurality of closing wheels 1306 are attached. The agricultural implement 1300 is attachable to a towing vehicle, such as a tractor, via a frame attachment 1308. In another example, the agricultural implement 1300 can be a multi-use single disc injection coulter, in which the ground engaging structure is mounted on a parallel linkage.

The opener disc 1304 is mounted to the main frame 1301 via a depending arm 1310, which is positioned in a generally vertical position and is attached to the main frame 1301 at Pivot A. Pivot A is a pivotable connection between the depending arm 1310 and the main frame 1301 that allows angular changes to the opener disc 1304 in a pivoting direction A around a vertical (Z) axis. Auxiliary components, such as the residue clearing wheels 1302, are mounted directly to the main frame 1301, independently of the depending arm 1310.

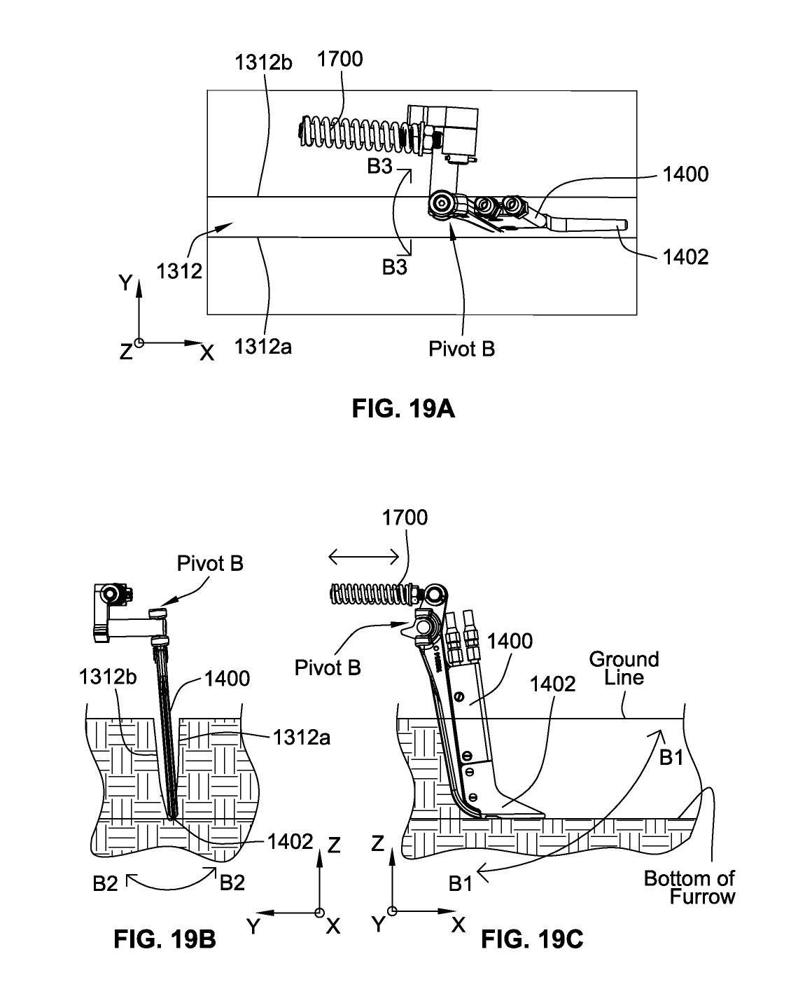

The angular changes of the opener disc 1304 in the pivoting direction A do not affect other auxiliary components. For example, the angular change of the opener disc 1304 does not cause an angular change to the residue clearing wheels 1302 (or other such auxiliary components). This is important because auxiliary components are interacting with the furrow being created and are not making the furrow themselves. The auxiliary components need to continue to act along the direction of motion. The angular change of the opener disc 1304 is further described below in reference to FIG. 19.

The opener disc 1304 is adapted to form a furrow 1312 having a generally V-shaped profile defined by two inclined sidewalls 1312a, 1312b. The V-shaped profile, as shown, is a theoretical cross-section of the furrow 1312. As shown, for reference purposes, a first horizontal (X) axis is generally along the length of the furrow 1312 and a second horizontal (Y) axis is generally perpendicular to the length of the furrow 1312. The forming of the furrow 1312 is also known as opening or cutting a slot in the ground.

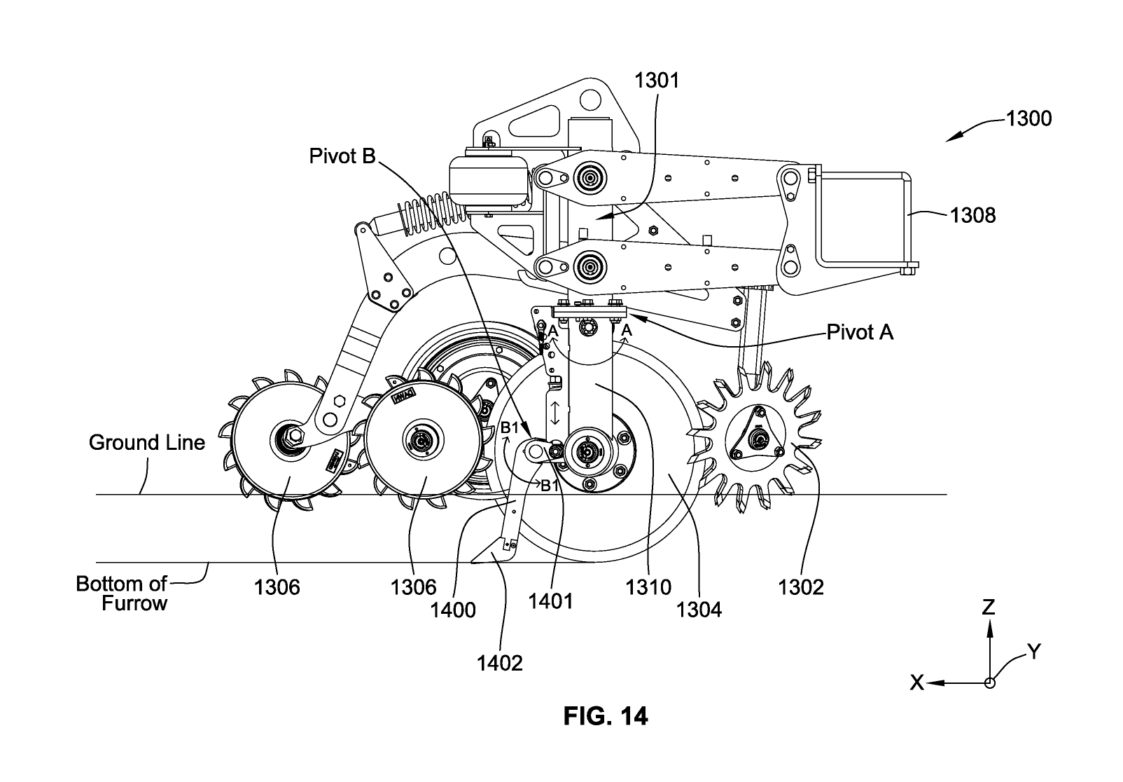

In addition to the pivotable connection of Pivot A, the agricultural implement 1300 further includes another pivotable connection at a Pivot B. Pivot B is a pivotable connection between a tine 1400 (shown in FIG. 14) and a pivoting assembly 1401. As explained in more detail below, Pivot B allows free movement of the tine 1400 while the tine 1400 is moving in the furrow 1312.

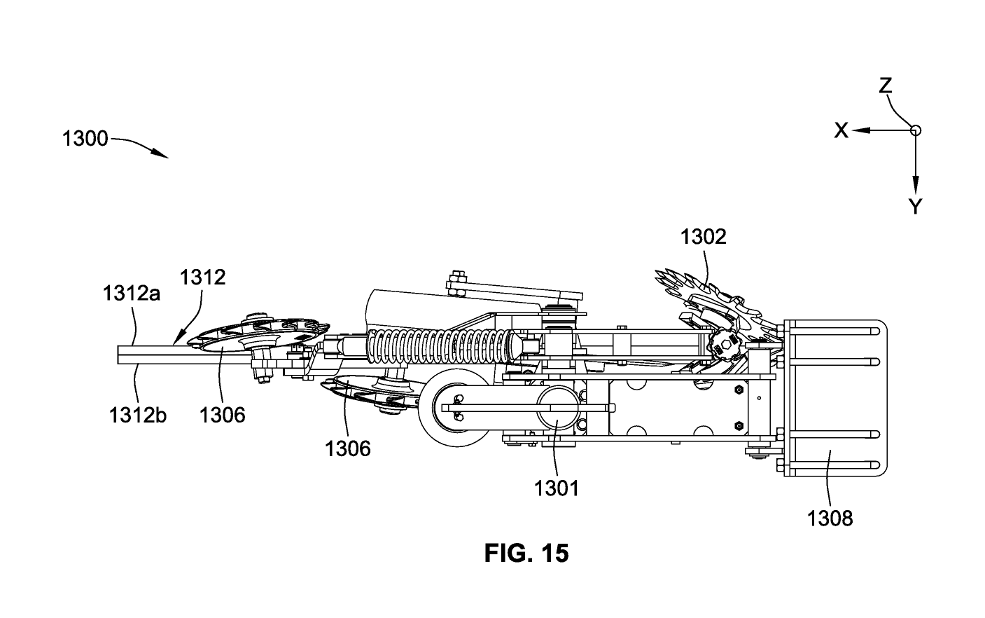

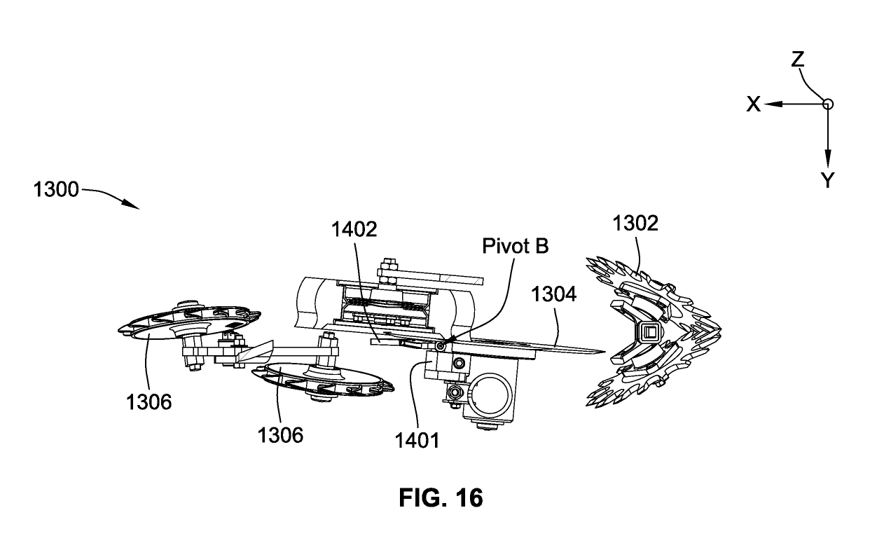

Referring to FIGS. 14-16, the tine 1400 is generally a floating rudder-type injection tine that has various features, including features similar to the tine 618 described above in reference to FIGS. 7-11. For example, the tine 1400 is connected to a diffuser 1402 at a bottom end and to the pivoting assembly 1401 at a pivoting end.

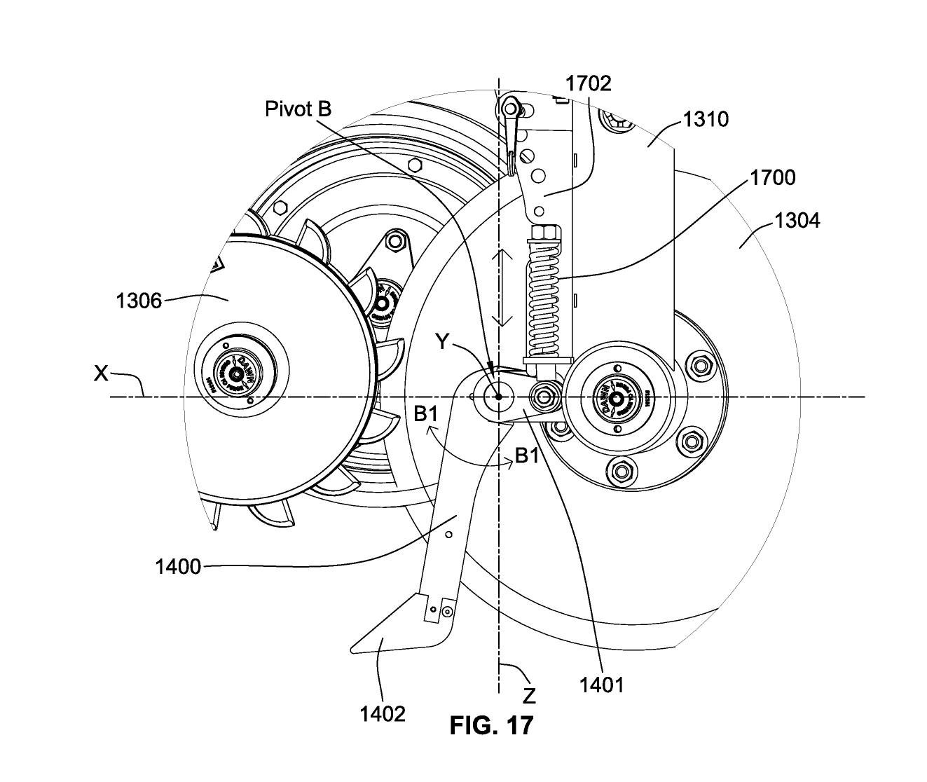

Referring generally to FIGS. 17-20, the tine 1400 is freely movable in three independent pivotable directions B1, B2, and B3. Referring more specifically to FIG. 17, a first pivotable movement B1 is around the Y axis and allows the tine 1400 to flex over obstructions, such as rocks, when the tine 1400 is in motion. Thus, this pivoting movement is advantageous at least because it eliminates, or greatly reduces, the likelihood of damage that the obstructions may cause to the tine 1400 or other related components. The first pivotable movement B1 is also shown in FIG. 19C.

To achieve the first pivotable movement B1, the tine 1400 is biased via a spring 1700. The spring 1700 exerts a linear force that can be exerted, depending on the orientation of the spring 1700, either in a downward direction along the Z axis (toward the furrow 1312), as shown in FIG. 17, or in a generally horizontal direction along the X axis, as shown in FIG. 19C. The spring 1700 is attached to a mounting bracket 1702, which is connected to the depending arm 1310, such that a lower end of the spring 1700 forces the tine 1400 downward in a flexible manner. The force of the spring 1700 helps maintain the diffuser 1402 near the bottom of the furrow 1312, and provides the tine 1400 with the ability to flex upwardly as required by the soil conditions. As such, the spring 1700 allows the diffuser 1402 to temporarily flex upwardly over rocks and other obstructions. Optionally, in accordance with environmental conditions, the spring pressure is adjustable to provide a specific desired force.

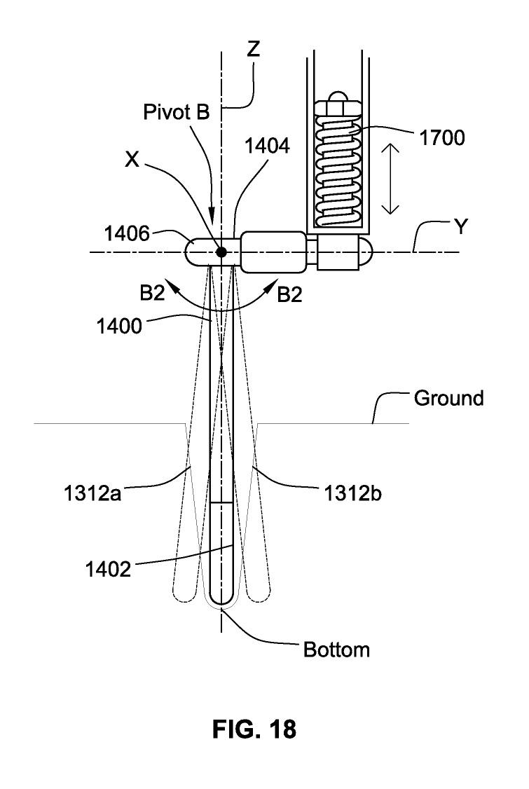

Referring more specifically to FIG. 18, the tine 1400 is further freely movable in a second pivotable direction B2 around the X axis. The tine 1400 has a pivoting end 1404 that is attached to a shaft 1406, which is generally horizontal and extends between a lower end of the spring 1700 and the centerline of the furrow 1312. Thus, in this embodiment, the tine 1400 is offset from the spring 1700. The second pivotable direction B2 is also shown in FIG. 19B.

Referring more specifically to FIG. 19A, the tine 1400 is further freely movable in a third direction B3 around the Z axis. The free movement of the tine 1400 in the third pivotable direction B3 allows the tine 1400 to stay centered on the furrow 1312, between the two furrow sidewalls 1312a, 1312b, as the angle of the opener disc 1304 is changed and, also, it prevents the tine 1400 from riding out of the furrow 1312 if the agricultural implement 1300 is driven around a curve. If the tine 1400 is not running in the furrow 1312, but interferes with one of the sidewalls 1312a, 1312b, the tine 1400 will tend to ride out of the ground, build with mud, grab plant residue, and fail to properly seal ammonia or other chemicals applied via the tine 1400.

As noted above, the free movement of the tine 1400 in all three pivoting directions B1-B3 allows the diffuser 1402 to self-locate the desired maximum depth of the furrow 1312. Thus, the tine 1400 is connected at Pivot B such that it can advantageously pivot (or rotate) freely in an independent manner in three directions: a first pivoting direction B1 around the Y axis, a second pivoting direction B2 around the X axis, and a third pivoting direction B3 around the Z axis.

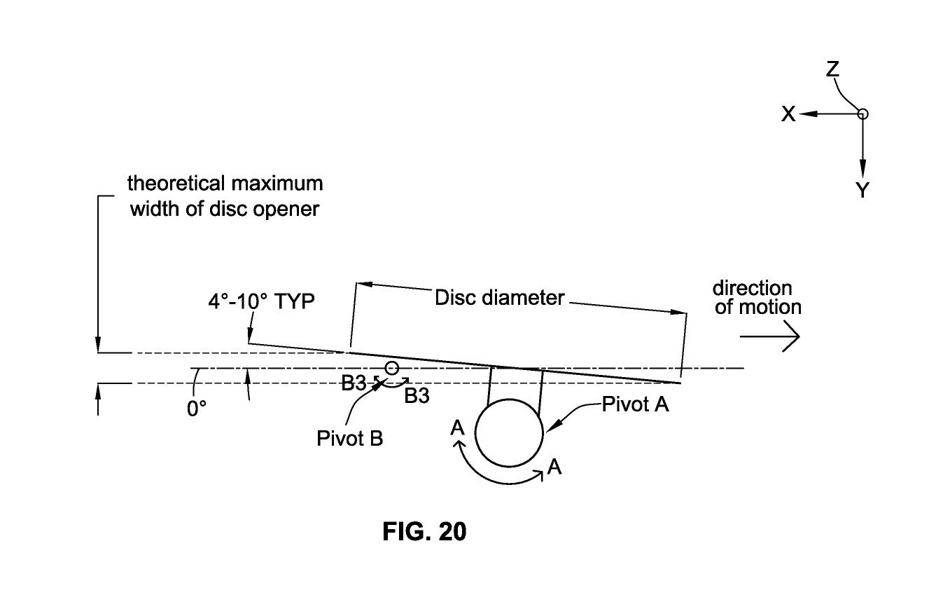

Referring more specifically to FIG. 20, a typical operation would generally require an angular adjustment of about 4°-10° between the centerline of the furrow and the maximum change in angle of the opener disc. Specifically, the angle of the opener disc is changeable from an initial setting of about 0°, which is generally along the length of the furrow, to a second setting that can range from about 4° to about 10°.

The pivotable free movement of the rudder type injection tine at the Pivot B allows the tine to float independently about three different axes and, accordingly, to track inside the furrow. The angular change of the opener disc about the vertical axis at Pivot A helps achieve furrows of different width. As the agricultural implement 1300 is being pulled in one direction, the opener disc forms a furrow with a desired width.

The ability to change the angle of the opener disc helps achieve different size fertilizer openings and different levels of soil and residue disturbance. Different product applications require a different size furrow be cut in the ground. For example, for manure, where a large volume of product is applied, a large furrow is necessary. In another example, anhydrous ammonia, where there is risk of product escaping to environment as gas, it is generally desired to have a small furrow opening.

Power consumption and soil disturbance/tillage are also affected by blade angle. As such, making easy adjustment of the angle between the plane of the opener disc and the direction of motion allows the opener disc to be used flexibly for multiple purposes.

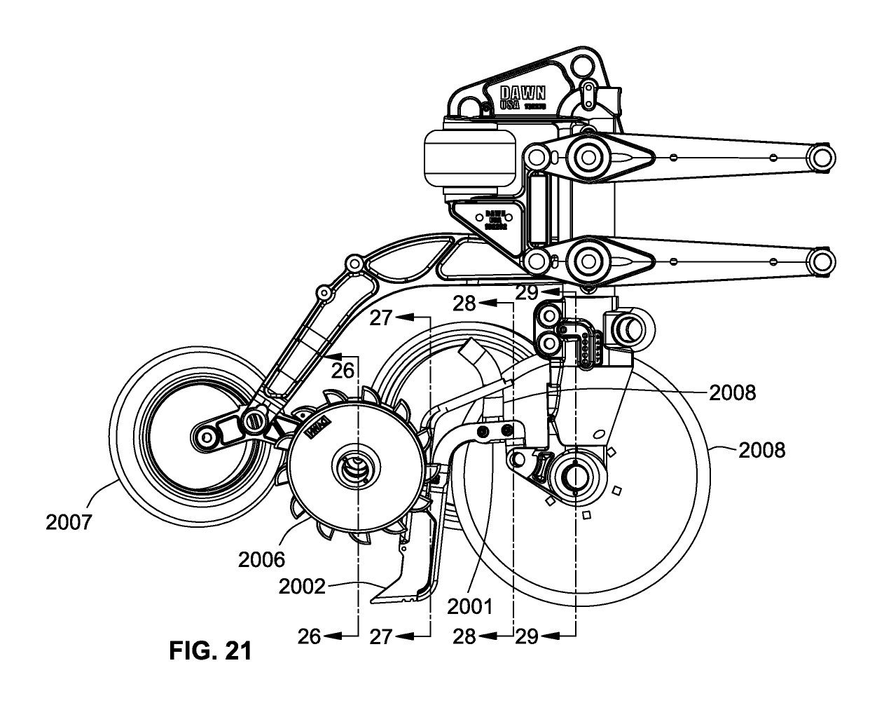

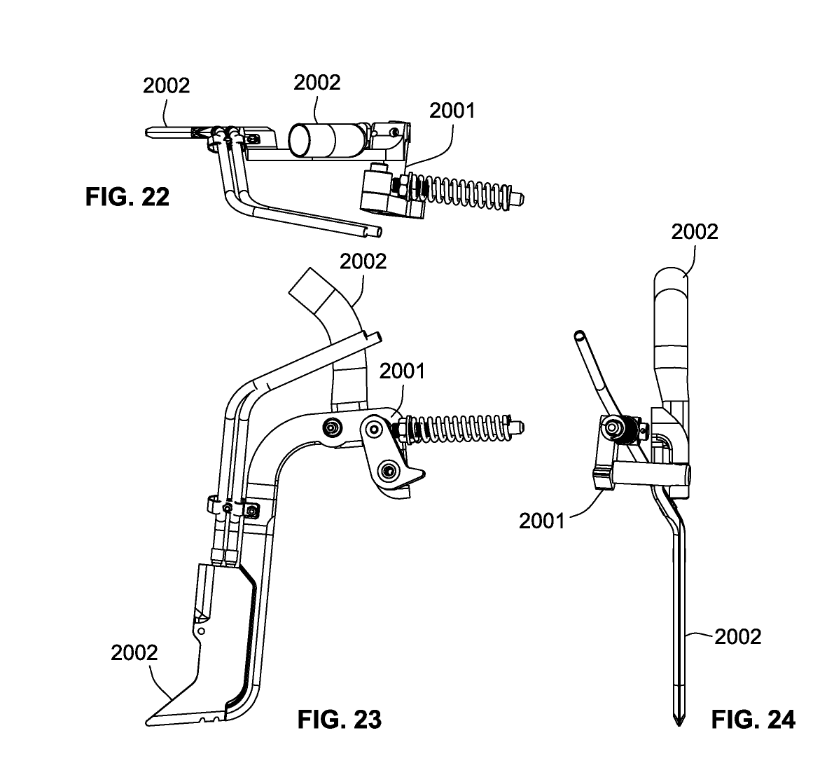

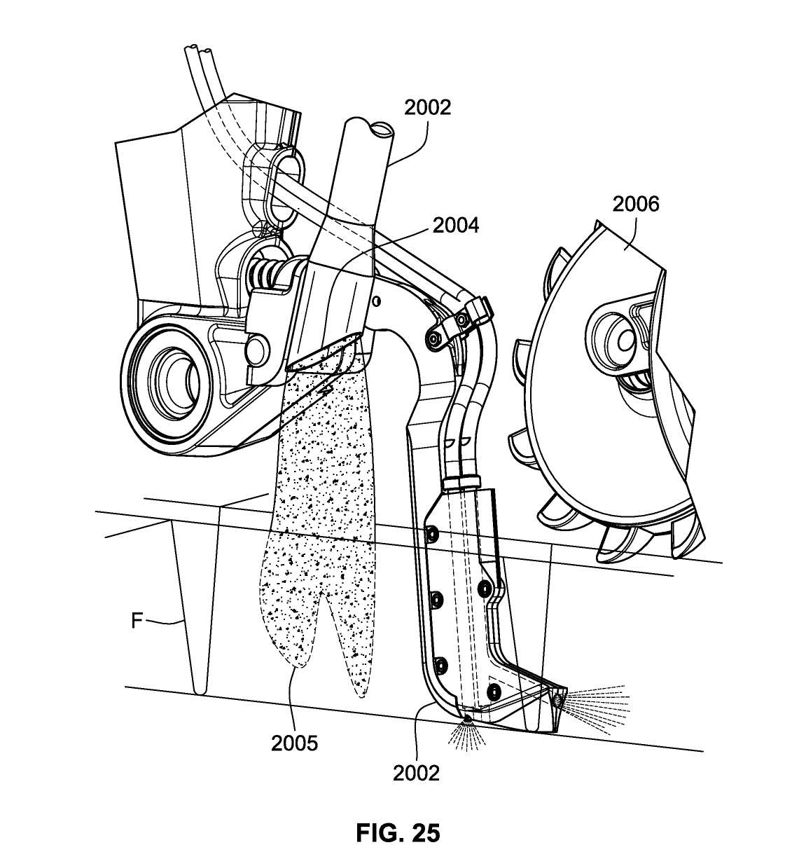

FIGS. 21-25 illustrate a modified embodiment for applications where it is desired to deposit dry, granular fertilizer, either in addition to or instead of fluid fertilizer. In this embodiment, a dry fertilizer delivery tube 2000 is mounted on the same connector 2001 that carries a fluid-delivery device 2002. The upper end of the tube 2000 is adapted for connection to a flexible tube that receives dry fertilizer from a conventional hopper (not shown) and conducts that fertilizer to the delivery tube 2000. The lower end 2004 of the tube 2000 is positioned far enough above the soil to clear common obstructions such as rocks, but close enough to the soil to direct the exiting dry fertilizer 2005 into the furrow F formed by the opener 2008, as depicted in FIG. 25. The lower end 2004 of the tube 2000 is preferably located above the axis of rotation of the opener 2008.

Because the dry-fertilizer delivery tube 2000 is mounted on the same connector 2001 as the fluid-delivery device 2002, the tube 2000 follows the movements of the fluid-delivery device 2002 as it tracks the furrow F. The tube 2000 is located in front of the fluid-delivery device 2002 so that the dry fertilizer 2005 is delivered to the furrow F while the furrow is wide open, i.e., well in front of the closing wheels 2006 and 2007 that close the furrow F around the fluid-delivery device 2002.

The outer periphery of the front closing wheel 2006 is spaced rearwardly from the outer periphery of the opening disc, which reduces the entrapment of debris between the opening disc 2008 and the closing wheels 2006, 2007.

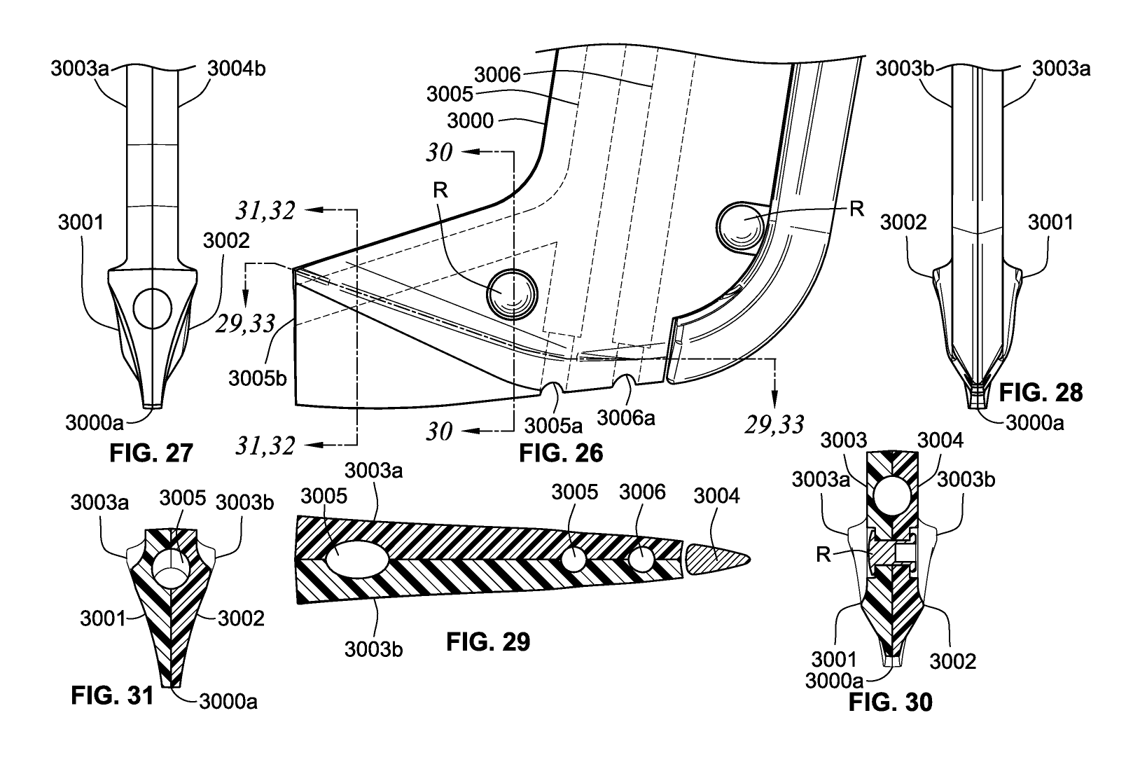

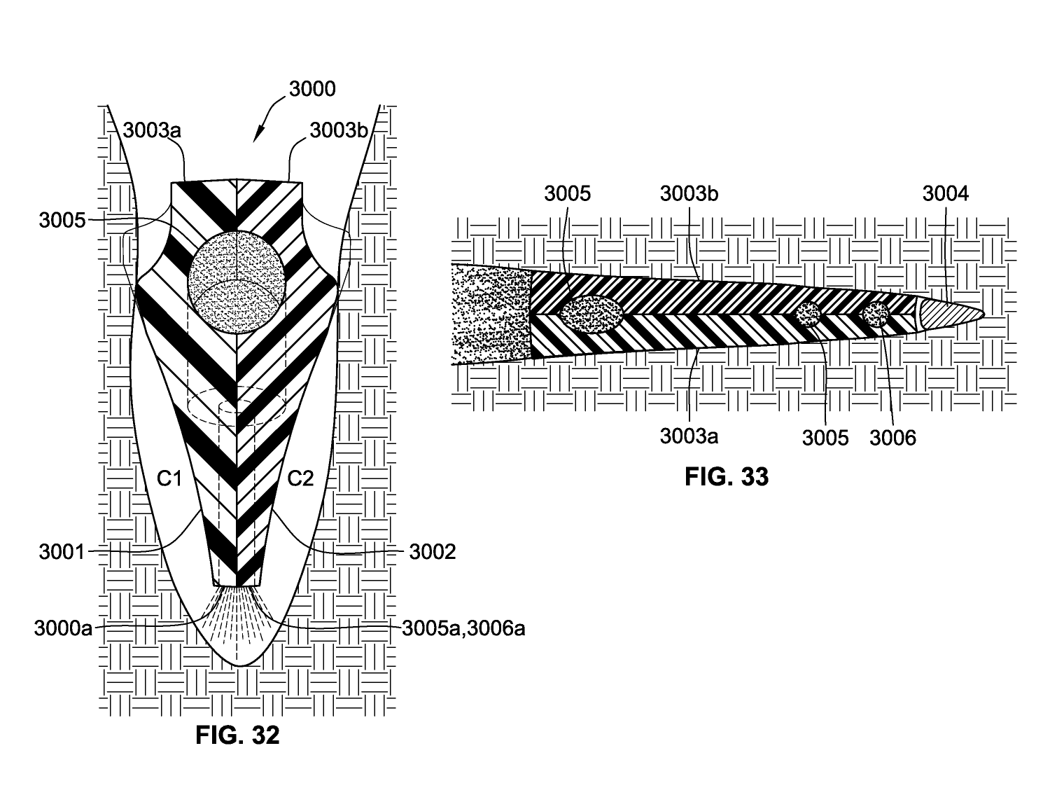

FIGS. 26-33 illustrate a modified embodiment in which a fluid delivery device 3000 has a bottom wall 3001 that is narrower than the average width of the lower portion of the furrow F. A pair of side walls 3002 and 3003 extend upwardly and outwardly to engage the side walls of the furrow above the discharge openings for the fluid fertilizer. This increases the amount of fluid fertilizer that becomes entrapped within the soil, thus reducing fertilizer loss and improving the efficiency of the fertilizing operation. In addition, by engaging the side walls of the furrow, the upper ends of the flared side walls 3002 and 3003 form cavities C1 and C2 along the lower portions of those side walls, as depicted in FIG. 28. These cavities accumulate soil broken from the furrow side walls and further enhance entrapment of the fluid fertilizer components discharged from the bottom wall 3001 and the trailing end wall 3004 of the device 3000.

The illustrative dispensing device 3000 shown in FIGS. 26-33 is formed by riveting together (see rivets R in FIGS. 26 and 30) two molded polymeric parts 3010 and 3011 that are mirror images of each other, and a forged metal tip 3012. The opposed surfaces of the two molded parts 3010 and 3011 include mating recesses that form a pair of passageways 3012 and 3013 for receiving two fluids (e.g., low-pressure liquid and high-pressure ammonia gas), as described above in connection with FIG. 25. The passageways 3012 and 3013 extend upwardly to a pair of inlet ports 3014 and 3015 adapted to be connected to two supply tubes such as the tubes 636 and 640 described above. As can be seen in FIG. 26, the rear passageway 3012 is bifurcated to dispense the low-pressure material in this passageway from both a bottom port 3016 and a rear port 3017, which normally remains open even if the bottom port 3016 becomes clogged. The high-pressure material in the passageway 3012 (e.g., pressurized ammonia gas) is dispensed only through a bottom port 3018, where it mixes with the material being discharged from the adjacent port 3016.

Different optional cross-sectional configurations for the fluid delivery device 3000 are illustrated by modified delivery devices 3000a through 3000f in FIGS. 34A through 34F, respectively. These configurations include abrupt changes in the transverse widths of the devices 3000a-3000f, thereby forming respective pairs of “wings” 3020a-3020f and 3021a-3021f that have the effect of pulling the delivery device downwardly into the soil. This can create additional disturbances and surface area to entrap the fluid fertilizer, and also permits the use of laterally bifurcated passageways that enable the fluid fertilizer to be discharged adjacent or directly into the side walls of the furrow, as described in more detail below. As depicted in FIGS. 34A-34F, the upper surfaces and/or the lower surfaces of the wings 3020a-3020f and 3021a-3021f can have different angles of inclination, as well as different lengths and thicknesses, to achieve different effects or to accommodate different soil conditions.

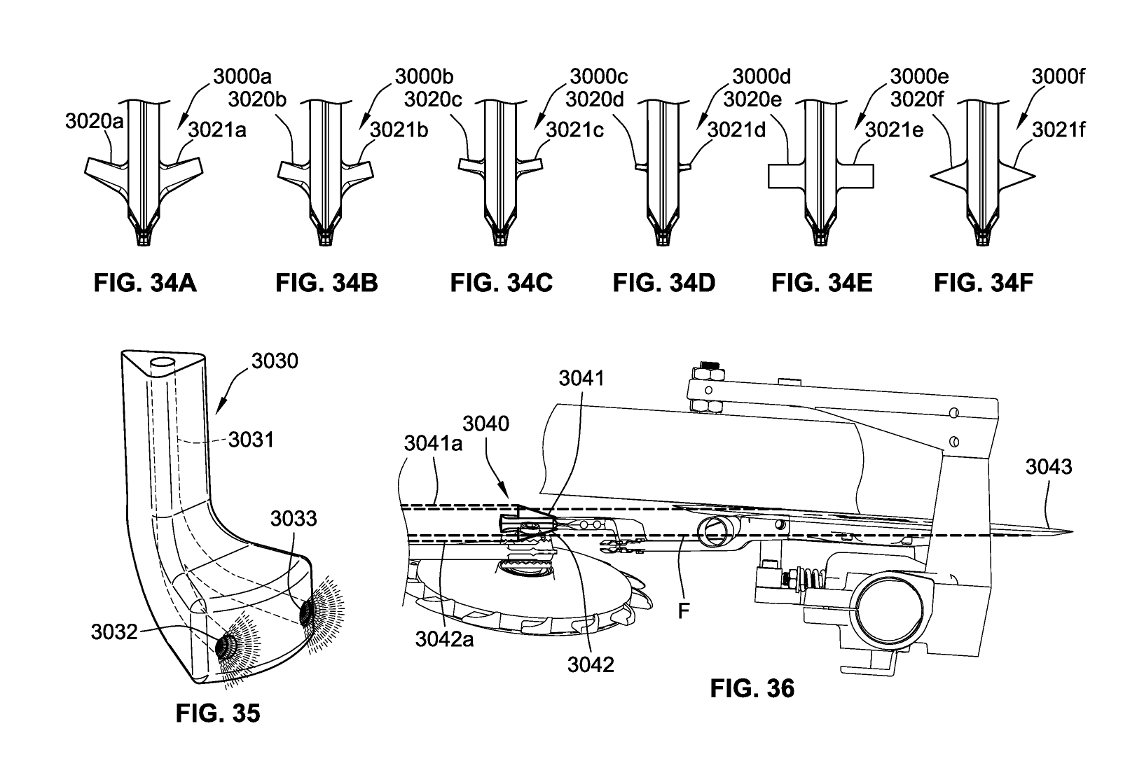

FIG. 35 illustrates another modified fluid delivery device 3030 in which the bottom portion of the device 3030 flares laterally outwardly, on both sides, toward its trailing end, and an internal fluid passageway 3031 is laterally bifurcated to dispense fertilizer from two laterally spaced ports 3032 and 3033 in the trailing end wall 3034 of the device 3030.

FIG. 36 illustrates a further modified fluid delivery device 3040 that includes a pair of side wings 3041 and 3042 that extend into the side walls of a furrow F, i.e., the distance between the tips of the two wings is greater than the width of the furrow F at the depth where the wings 3041 and 3042 are located. Thus, the tips of the wings 3041 and 3042 cut slots or grooves in the side walls of the furrow F, thereby enhancing entrapments of the discharged fluids in the soil.

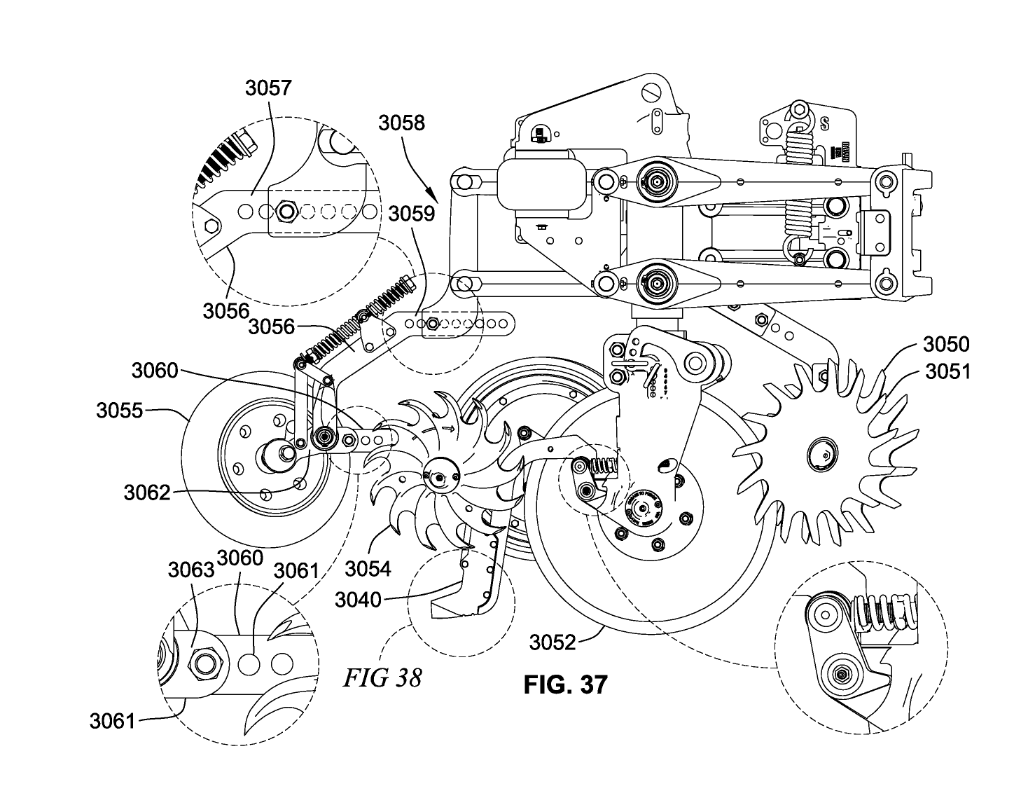

FIG. 37 illustrates a complete row unit utilizing the dispensing device 3040 described above. This row unit also includes a pair of clearing wheels 3050 and 3051, an opening disc 3052, a gauge wheel 3053, and a pair of closing wheels 3054 and 3055. To permit adjustment of the longitudinal positions of the closing wheels 3054, 3055 relative to the rest of the row unit, the upper end of the support arm 3056 for the closing wheels is provided with multiple holes 3057 for attaching the arm 3056 to a linkage 3058. To adjust the position of the arm 3056, the operator removes one or more bolts and nuts 3059 that attach the arm 3056 to the linkage 3058, moves the arm 3056 to the desired position, and then re-inserts the bolts and nuts 3059 to rigidly attach the arm 3056 to the linkage 3058 in the desired position.

A similar adjustment mechanism is provided for adjusting the longitudinal position of the front closing wheel 3054 relative to the rest of the row unit, including the dispenser 3040 and the rear closing wheel 3055. Specifically, the front end of the support arm 3060 for the front closing wheel is provided with multiple holes 3061 for attaching the arm 3060 to the support arm 3056. To adjust the position of the arm 3060, the operator removes one or more bolts and nuts 3063 that attach the arm 3060 to the arm 3056 via a link 3062, moves the arm 3060 to the desired position, and then re-inserts the bolts and nuts 3063 to rigidly attach the arm 3060 to the link 3062, and thus to the main support arm 3056, in the desired position.

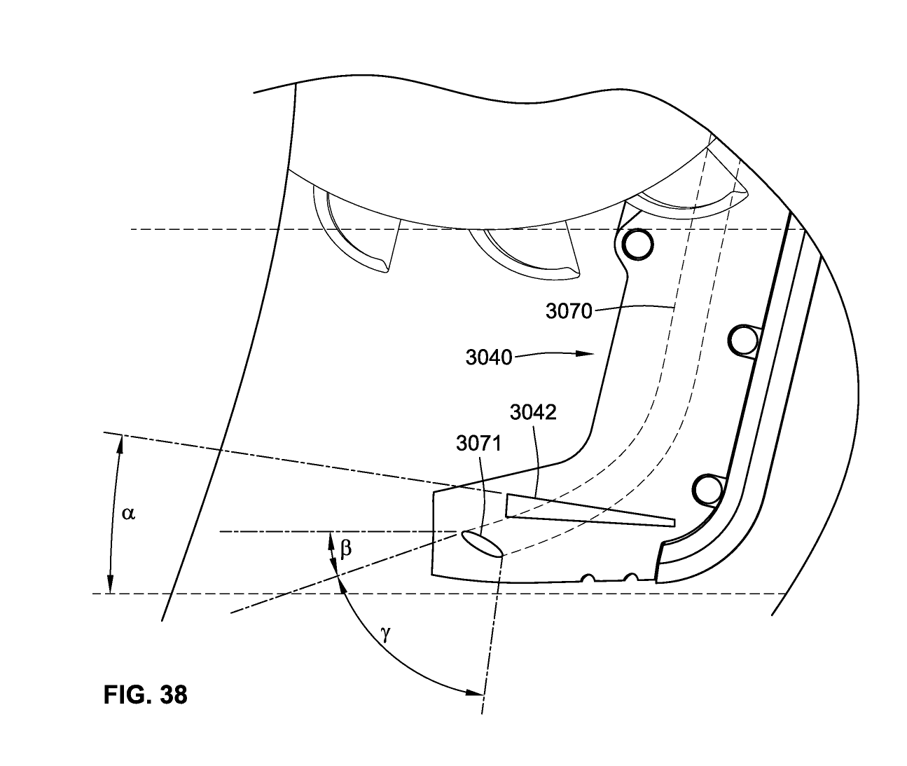

The lower portion of the dispensing device 3040 is shown in more detail in FIG. 38. The wing 3042 is inclined upwardly toward its trailing edge at a pitch angle α, and has a progressively reducing thickness from its trailing edge to its leading edge, so that advancing movement of the row unit causes the wings 3041, 3042 to draw the dispensing device 3040 downwardly against the bottom of the furrow. The lower end portion of an internal passageway for ammonia gas is angled downwardly to a discharge port 3071 at an angle β, so that the ammonia is discharged in a pattern having an included angle γ to spread the ammonia over a substantial area of the furrow walls.

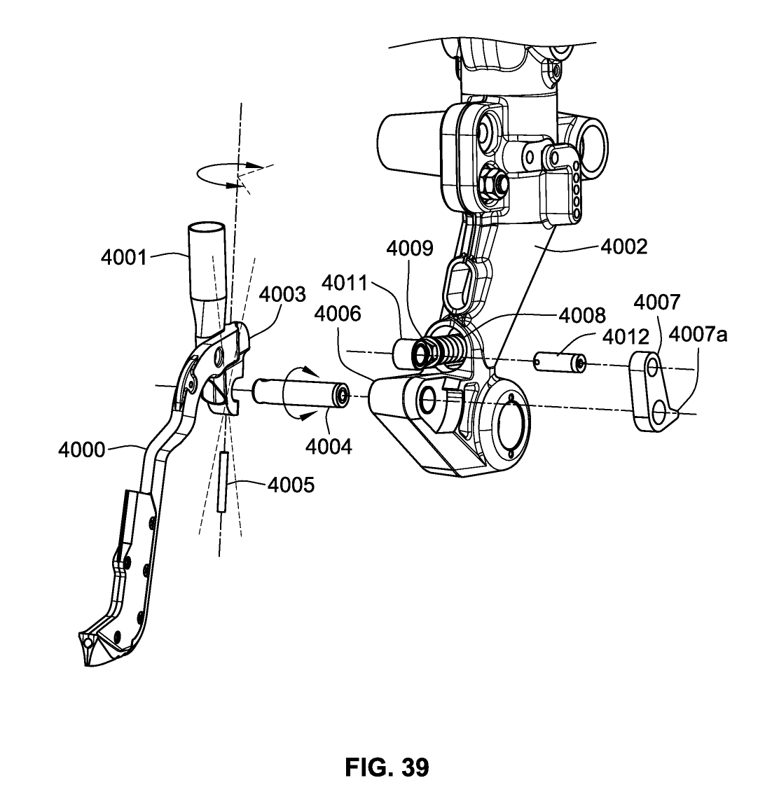

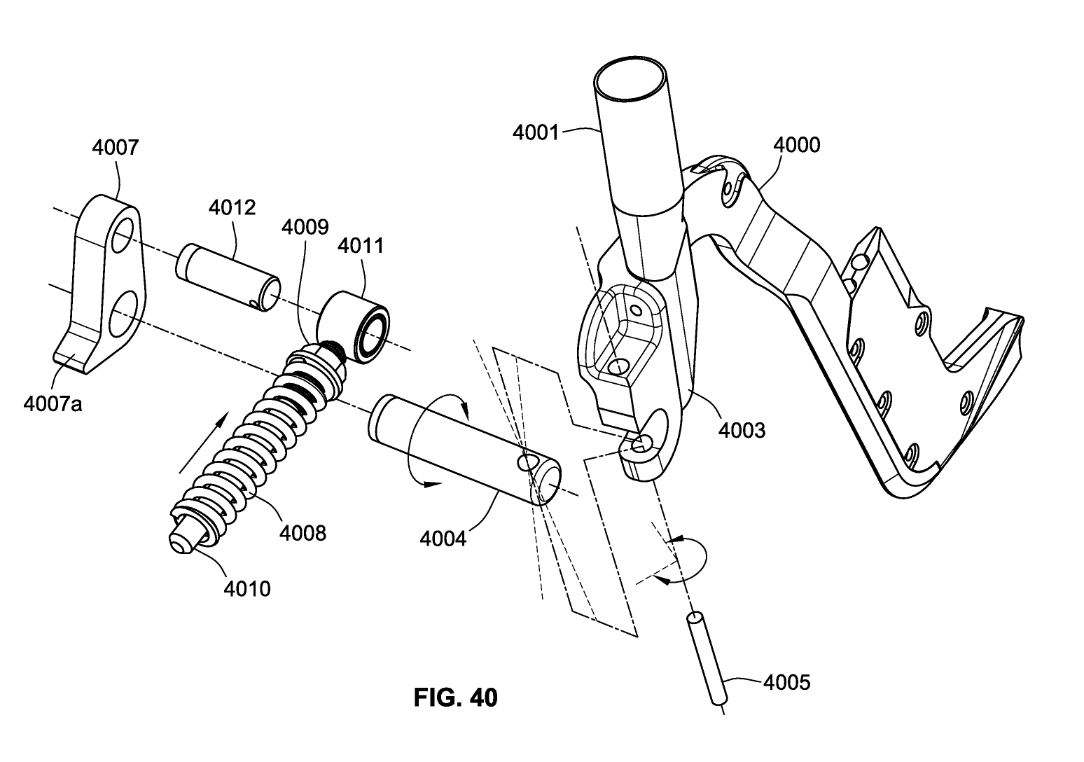

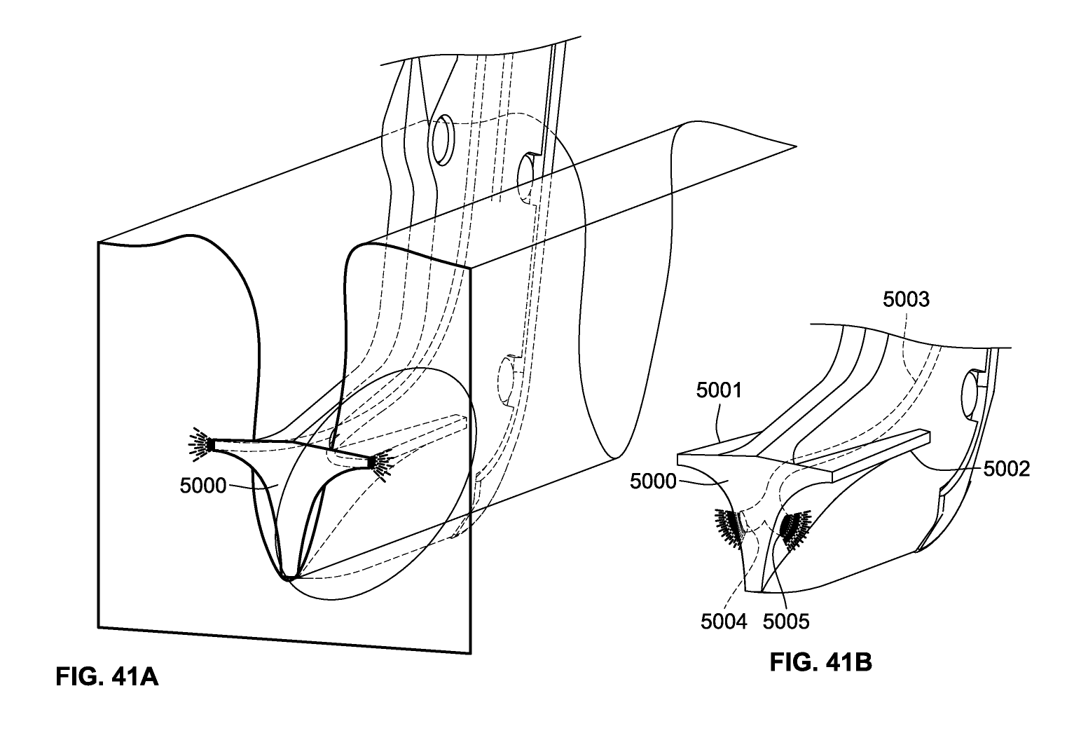

FIGS. 39 and 40 illustrate the details of the mechanism that attaches the main support arm 4000 of the dispensing device 3040, as well as the solid-fertilizer dispensing tube 4001, to a stem 4002 depending from the main linkage attached to the frame of the row unit. The upper end of the support arm 4000 terminates in a structure 4003 that includes a notch 4003a that receives one end of a pin 4004, which is secured to the structure 4003 by a pin 4005 that passes through both the structure 4003 and the pin 4004. The main body portion of the pin 4004 passes through a housing 4006 on the lower end of the stem 4002, and the second end of the pin 4004 is attached to a limiting link 4007. This arrangement permits the arm 4000 to pivot both vertically, around the axis of the pin 4004, and horizontally, around the axis of the pin 4005. The notch 4003a is deep enough to permit the structure 4003 to pivot horizontally around the end of the pin 4004.

An adjustable downward biasing force is applied to the arm 4000 by a compressed coil spring 4008, whose force can be adjusted by turning a nut 4009 threaded onto a shaft 4010 telescoped through the spring 4008, to either compress the spring 4008 or allow it to expand. The end of the shaft 4010 engages a sleeve 4011 that is linked to the limiter 4007 by a pin 4012. The limiter 4007 is attached to the pin 4004, so the spring force transmitted to the limiter is in turn transmitted by the pin 4004 to the housing 4003 and thus to the support arm 4000. Thus, adjusting the compression of the spring 4008 adjusts the down pressure applied to the arm 4000 and the dispensing device carried by that arm. To limit the vertical pivoting movement of the support arm 4000, the limiter 4007 has a protruding tip 4007a that engages a stationary stop flange 4013 (see FIG. 37) to limit the rotational movement of the pin 4004, and thus the vertical pivoting movement of the arm 4000.

FIGS. 41A and 41B illustrate another modified dispensing device that forms a T-shaped trailing end wall 5000, with the crossbar of the T formed by the rear ends of a pair of wings 5001 and 5002 that are substantially parallel to the bottom of the dispenser. The portion of the dispenser below the wings 5001, 5002 tapers inwardly toward the trailing end, thereby forming a pair of cavities below the two wings. The distance between the tips of the two wings is preferably slightly greater than the width of the furrow F at that elevation, as depicted in FIG. 41A, so that the cavities beneath the wings are closed at the top. The interior of the dispenser forms a bifurcated passageway 5003 for the fluid to be discharged, and the discharge ports 5004 and 5005 are located near the trailing end of the dispensing device, where the furrow is already being closed by the front closing wheel. Thus, the discharged fluid is largely entrapped within the cavities and thus has little chance to escape from the furrow rather than being entrained in the soil.

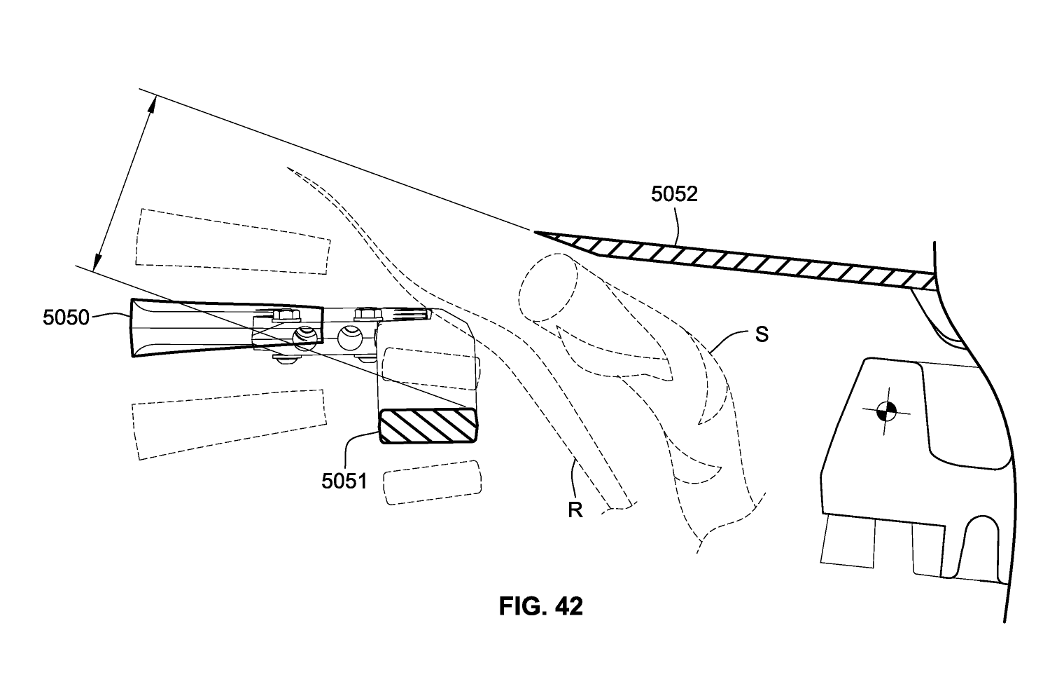

FIG. 42 is a diagrammatic illustration of a dispensing device 5050 carried by a support arm 5051 spaced both laterally and rearwardly from the trailing edge of an opening disc 5052. Field debris in the form of a corn stalk fragment S and a root fragment R are depicted passing through the gap between the dispensing device and the opener 5052, and it can be seen that there is ample room for the debris to pass through the implement rather than becoming caught and clogging the implement. It will be noted that the upper portion of the support arm 5051 is laterally offset from the lower portion (see also FIGS. 39 and 40), which further opens the space between the dispensing device and the opener to permit field debris to pass through the implement.

It will be evident to those skilled in the art that the invention is not limited to the details of the foregoing illustrated embodiments and that the present invention may be embodied in other specific forms without departing from the spirit or essential attributes thereof. The present embodiment is therefore to be considered in all respects as illustrative and not restrictive, the scope of the invention being indicated by the appended claims rather than by the foregoing description, and all changes which come within the meaning and range of equivalency of the claims are therefore intended to be embraced therein.

1. An agricultural implement for delivering fertilizer into a furrow in the soil of an agricultural field, the system comprising
a main frame,
an opener device attached to the main frame for forming a furrow in the soil,
a closing device having an axis of rotation and trailing the opener device for closing the furrow, and
a dispensing device for delivering a fluid into the furrow, the injection device having a bottom end extending downwardly into the furrow between the opener device and the axis of rotation of the closing device, an inlet port for receiving said fluid, at least two outlet ports for discharging said fluid into different regions of said furrow, and a bifurcated passageway for conducting said fluid from said inlet port to said outlet ports.

2. The agricultural implement of claim 1 in which said outlet ports are located to discharge said fluid onto or adjacent to both of the side walls of said furrow.

3. The agricultural implement of claim 1 in which said dispensing device includes at least two inlet ports for receiving two different fluids.

4. The agricultural implement of claim 1 in which said dispensing device has a bottom wall having a width that is narrower than the average width of the bottom half of said furrow, and side walls that extend upwardly and outwardly from said bottom wall to engage the side walls of said furrow, thereby forming cavities in said furrow between said side walls of said dispensing device and the side walls of the furrow.

5. The agricultural implement of claim 1 in which said dispensing device is mounted to permit movement of said device independently about at least two different axes.

6. The agricultural implement of claim 5 in which said dispensing device is mounted to permit movement of said device independently about at least three different mutually perpendicular axes.

7. The agricultural implement of claim 5 in which one of said axes is a horizontal axis that is generally perpendicular to the length of the furrow, and another of said axes is a vertical axis that is generally perpendicular to the soil.

8. A method of delivering fertilizer into a furrow in the soil of an agricultural field, using an opener device for forming a furrow in the soil, a closing device having an axis of rotation and trailing the opener device for closing the furrow, and a dispensing device for delivering a fluid into the furrow, the method comprising
locating said dispensing device at a location between the opener device and the axis of rotation of the closing device,
delivering fluid fertilizer from said dispensing device into at least two different regions of said furrow.

9. The method of claim 8 in which said fluid fertilizer is ammonia gas.

10. The method of claim 8 in which said fluid fertilizer comprises two different fluids, one of which is a pressurized liquid and the other of which is a gas pressurized to a pressure above that of said pressurized liquid.

11. The method of claim 10 in which said pressurized liquid is discharged rearwardly from a location above the bottom of said furrow, and said pressurized gas is discharged downwardly into the bottom of said furrow.

12. An agricultural implement for delivering fertilizer into a furrow in the soil of an agricultural field, the system comprising
a main frame,
an opener device attached to the main frame for forming a furrow in the soil,
a closing device having an axis of rotation and trailing the opener device for closing the furrow, and
a dispensing device for delivering a fluid into the furrow, the injection device having a lower end adapted to extend downwardly into the furrow between the opener device and the axis of rotation of the closing device, at least one inlet port for receiving said fluid, at least one outlet port for discharging said fluid into said furrow, at least one fluid passageway connecting said at least one inlet port to said at least one outlet port, a bottom wall having a width that is narrower than the average width of the bottom half of said furrow, and side walls that extend upwardly and outwardly from said bottom wall to engage the side walls of said furrow, thereby forming cavities in said furrow between said side walls of said dispensing device and the side walls of the furrow.

13. The agricultural implement of claim 12 in which said cavities are formed below said engagement of said side walls of said furrow by said side walls of said dispensing device.

14. The agricultural implement of claim 12 in which said side walls of said dispensing device form a pair of wings that penetrate the side walls of said furrow.

15. The agricultural implement of claim 14 in which said wings progressively increase in thickness from the front edges thereof to the rear edges.

16. The agricultural implement of claim 14 in which said dispensing device includes an outlet port in each of the side walls of said device, and said outlet ports are located below said wings.

17. An agricultural implement for delivering fertilizer into a furrow in the soil of an agricultural field, the system comprising
a main frame,
an opener device attached to the main frame for forming a furrow in the soil,
a pair of closing wheels including a front wheel for engaging the soil on one side of said furrow and a rear wheel for engaging the soil on the other side of said furrow, said closing wheels trailing the opener device,
a dispensing device for delivering a fluid into the furrow, the injection device having a bottom end extending downwardly into the furrow between the opener device and the axis of rotation of the front closing wheel, and
an adjustment mechanism coupled to said front closing wheel for adjusting the longitudinal position of said front closing wheel relative to said dispensing device.

18. The agricultural implement of claim 17 which includes a second adjustment mechanism for adjusting the longitudinal positions of both said front closing wheel and said rear closing wheel relative to said dispensing device.

19. The agricultural implement of claim 17 which includes a biasing device coupled to said dispensing device for urging said dispensing device downwardly into a furrow.

20. The agricultural implement of claim 19 which includes an adjustment mechanism for adjusting said biasing means to adjust the force urging said dispensing device downwardly into a furrow.
